(19) United States
(12) Patent Application Publication
(10) Pub. No.: US 2012/0085618 A1
(43) Pub. Date: Apr. 12, 2012

(54) RELEASABLE STEP LOCKING SYSTEM

(75) Inventors: Albrecht Duerrer, Bad Voeslau (AT); Chang-Jong Park, Vienna (AT)

(73) Assignee: OTIS ELEVATOR COMPANY, Farmington, CT (US)

(21) Appl. No.: 13/377,896

(22) PCT Filed: Jul. 20, 2009
(86) PCT No.: PCT/US2009/051118

§ 371 Date: Dec. 13, 2011

(51) Int. Cl. B66B 23/12; B66B 21/10; B66B 23/02

(52) U.S. Cl. 198/330; 198/333

(57) ABSTRACT

A passenger conveyor includes a releasable step locking system having a clamp, a lock, and an actuator. The clamp couples a step to a propulsion mechanism, the lock secures the coupling between the step and the propulsion mechanism, and the actuator changes the state of the lock so that the propulsion mechanism can be either engaged or disengaged from the step.

### BACKGROUND

The present invention relates to conveyor systems. In particular, the present invention relates to conveyor systems having steps and propulsion mechanisms.

Conventional passenger conveyors, such as moving walkways or escalators, include a series of pallets or steps that move in a closed loop. Passenger conveyors allow people to stand or walk along the steps while being transported across a distance. The steps are typically attached to a propulsion mechanism, which provides forward movement to the steps. More specifically, a drive sheave powers chain sprockets that impart motion to step chains thereby moving the steps, and any people located on the steps, along a predetermined track.

Step chains often include a pair of chain strands connected by a plurality of axles, which are permanently fixed to the steps. The fixation between the step and the step chains ensure that the steps follow any curvature along the track. In the case of an escalator, the track extends between a lower elevation and a higher elevation and back to the lower elevation in a closed loop. Moving walkways can have inclined, declined, or substantially flat tracks and sometimes include a pair of oppositely traveling, parallel walkways. Regardless of the track configuration, there is a need to reduce costs associated with maintenance and repair of passenger conveyors.

### SUMMARY

A conveyor includes a step for supporting load and a propulsion mechanism connected to the step for moving the step. The locking system attaches the step to the propulsion mechanism and includes a clamp, a lock, and an actuator. The clamp has a clamped state for coupling the step to the propulsion mechanism and an unclamped state for decoupling the step from the propulsion mechanism. The lock is attached to the clamp and has a locked state for securing the coupling between the step and the propulsion mechanism and an unlocked state for decoupling the propulsion mechanism from the step. The actuator is attached to both the lock and the step and is capable of changing the state of the lock.

A method of moving steps in a conveyor system includes moving steps around a closed loop path of the conveyor system, engaging the steps for a first portion of the closed loop path where the steps carry load and disengaging the steps for a second portion of the closed loop where the steps are load free.

A method of attaching and detaching a step to a propulsion mechanism for a conveyor system includes activating a locking system that attaches the step to the propulsion mechanism in the conveyor system, changing a lock from a first lock state to a second lock state in response to the activation of the locking system, and changing a clamp from a first clamp state to a second clamp state in response to the change in lock state such that the attachment between the step and the propulsion mechanism is altered.

### BRIEF DESCRIPTION OF THE DRAWINGS

FIG. 1 is a perspective view of an illustrative passenger conveyor with a portion broken away to show a step locking system in accordance with the present invention.

FIGS. 2A and 2B are schematic side views of a first embodiment of the step locking system.

FIGS. 3A and 3B are schematic side views of a second embodiment of the step locking system.

FIGS. 4A and 4B are schematic side views of a third embodiment of the step locking system.

FIGS. 5A-5F are a series of schematic side views showing operation of a step locking system.

FIGS. 6-9 are schematic side views of four embodiments of a clamp engaging a propulsion mechanism.

### DETAILED DESCRIPTION

As used herein, passenger conveyor includes both escalators and moving walkways. Similarly, step is used as a generic term that includes both steps for escalators and pallets for moving walkways. Also, propulsion mechanism is used as a generic term that includes chains, belts, and ropes or any other means of imparting movement to a step in a conveyor.

Conventionally, each step of a passenger conveyor is permanently fixed to a propulsion mechanism during operation. Traditional steps are only released from the propulsion mechanism for service and repair. While it is desirable to have a durable connection between the step and the propulsion mechanism, the connection need not be permanent fixation. In fact, a releasable attachment system between the step and propulsion mechanism could reduce expense and maintenance costs and increase drive comfort. The present invention is a releasable locking system for attachment of the step to the propulsion mechanism in passenger conveyors.

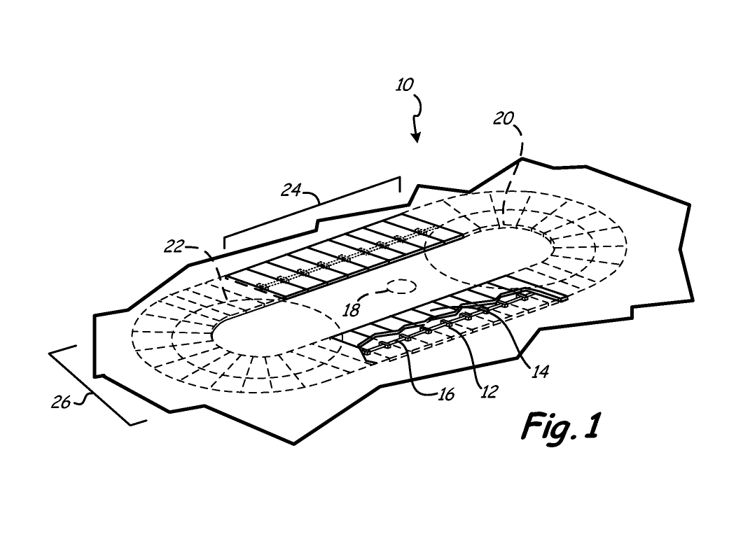

FIG. 1 is a perspective view of one example of a passenger conveyor 10 with a portion broken away to show releasable attachment system 12 between steps 14 and propulsion mechanism 16. Depicted in FIG. 1 are the components of passenger conveyor 10: releasable attachment system 12, steps 14, propulsion mechanism 16, machine 18, driving sheave 20, tension sheave 22, passenger portion 24, and return portion 26. Releasable attachment system 12 couples steps 14 to propulsion mechanism 16 in passenger portion 24 and decouples steps 14 from propulsion mechanism 16 during return portion 26 of passenger conveyor 10.

Although passenger conveyor 10 is depicted in FIG. 1 as a race-track style moving walkway, the invention is not so limited and may apply to other types of moving walkways and passenger conveyors such as escalators. Releasable attachment system 12 is located between steps 14 and propulsion mechanism 16. Steps 14, which form the moving walkway of passenger conveyor 10, have a top surface for supporting passengers and a bottom surface connected to releasable attachment system 12. In other embodiments, releasable attachment system is connected to a side of each step 14. Steps 14 can take many shapes such as, but not limited to, rectangles, squares, circles, and half-moons. A first end of releasable attachment system 12 is attached to the bottom surface of step 14 and an opposing second end of releasable attachment system 12 is either coupled with, or decoupled from, propulsion mechanism 16. The cutaway portion of FIG. 1 depicts releasable attachment system 12 coupling steps 14 to propulsion mechanism 16. Propulsion mechanism 16 can be a chain, a rope, a belt or any other suitable means of moving steps 14. Machine 18 is centrally located so that it is adjacent and attached to driving sheave 20. Opposite to, and remote from, driving sheave 20 is tension sheave 22. Propulsion mechanism 16 extends around both driving sheave 20 and tension sheave 22 to form a closed loop path. Within one complete loop, there can be one or more passenger portions 24 for supporting passengers and one or more return portions 26 for returning steps 14 to a beginning of a passenger portion 24. In the race-track style passenger conveyor 10 depicted in FIG. 1, there are two passenger portions 24 separated by two return portions 26, which also happen to be turnarounds. In other embodiments that resemble more traditional escalators, a singular return portion 26 can extend upwardly from a lower landing to an upper landing underneath a singular passenger portion 24, which extends downwardly from an upper landing to a lower landing. Several embodiments are contemplated, but all embodiments share a commonality, namely, releasable attachment system 12 between step 14 and propulsion mechanism 16.

Passenger conveyor 10 is configured to move passengers and/or cargo from one location to another. Passengers can either stand or walk along steps 14 to be transmitted quickly from one location to another. Releasable attachment system 12 is either coupling or decoupling steps 14 from propulsion mechanism 16. Machine 18 powers and controls the operation of driving sheave 20. Driving sheave 20 imparts forward movement to propulsion mechanism 16, which moves in a closed loop between driving sheave 20 and tension sheave 22. When coupled via releasable attachment system 12, propulsion mechanism 16 keeps steps 14 in line such that they follow the same curvature throughout the closed loop of passenger conveyor 10. It is contemplated that releasable attachment system 12 will couple steps 14 to propulsion mechanism 16 during a first portion of passenger conveyor 10 such as, but not limited to passenger portion 22, and decouple steps 14 from propulsion mechanism 16 during a second portion of passenger conveyor such as, but not limited to return portion 22. Thus, as steps 14 are transmitted around the closed loop, they are coupled and decoupled from propulsion mechanism 16 via releasable attachment system 12 at predetermined intervals.

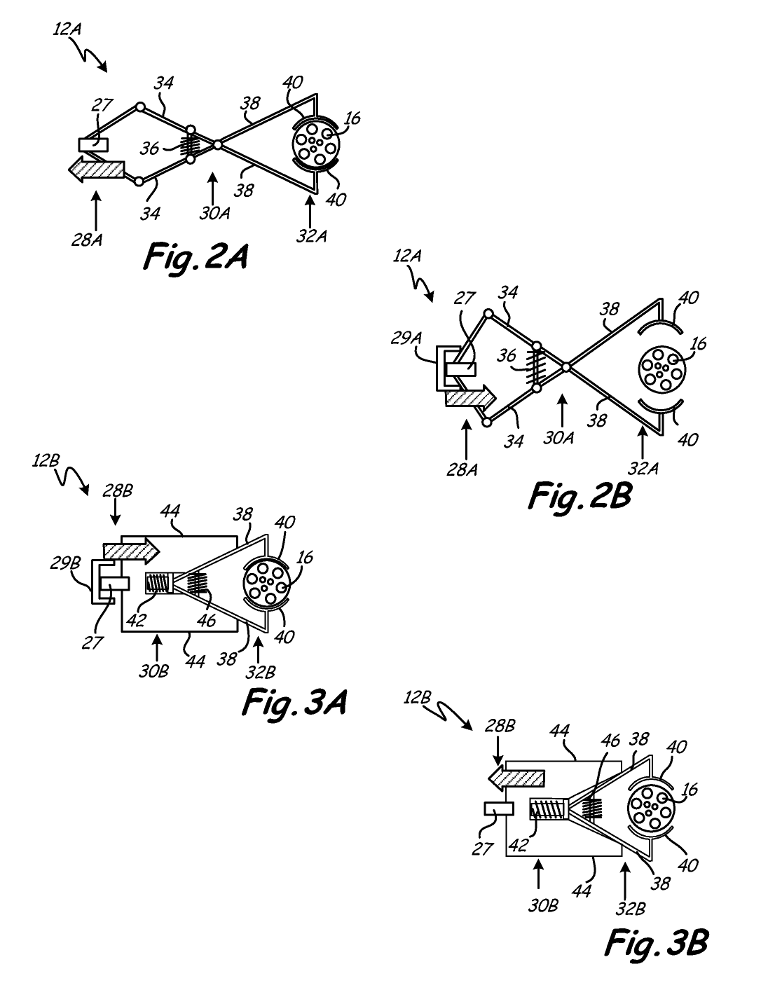

FIGS. 2A and 2B are schematic side views of a first embodiment of releasable attachment system 12A. FIG. 2A depicts releasable attachment system 12A coupling step 14 to propulsion mechanism 16, and FIG. 2B depicts releasable attachment system 12A decoupling step 14 from propulsion mechanism 16. Illustrated in FIGS. 2A and 2B are releasable attachment system 12A, propulsion mechanism 16, roller 27, actuator 28A, track 29A, lock 30A, clamp 32A, levers 24, first spring 36, arms 38, and hands 40. At rest, releasable attachment system 12A is coupling step 14 to propulsion mechanism 16. Activation of releasable attachment system 12A by roller 27-track 29 combination decouples step 14 from propulsion mechanism 16.

Releasable attachment system 12A includes three subsystems: actuator 28A, lock 30A, and clamp 32A. Actuator 28A is the left most portion of releasable attachment system 12A and includes roller 27-track 29 combination, although actuator 28A can assume other forms such as, but not limited to, a lever, a spring, or a solenoid. When actuator 28A is at rest or not actuated, track 29 is absent or at least not in contact with roller 27. When actuator 28A is activated or actuated, track 29 contacts a top surface of roller 27. Attached to actuator 28A and forming a middle portion of releasable attachment system 12 is lock 30A including levers 34 and first spring 36. Levers 34 first extend outwardly from either side of roller 27 to a point and then extend back inwardly toward first spring 36. First spring 36 extends between levers 34 near a center of releasable attachment system 12.

When lock 30A is locked or at rest, first spring 36 holds levers 34 close together and when lock 30A is activated or unlocked, first spring 36 pushes levers 34 outwardly. Attached to lock 30A and forming the right most portion of releasable attachment system is clamp 32A including arms 38 and hands 40. Arms 38 extend outwardly from the center of releasable attachment system 12 to a point and then extend back centrally to hands 40. Hands 40 extend centrally from the right most portion of each 38 arm and are shaped like a half-moon. When clamp 32A is at rest or clamped, hands 40 are in contact with an outer periphery of propulsion mechanism 16 and when activated or unclamped, hands 40 move outwardly away from propulsion mechanism 16. Propulsion mechanism 16 is shown as a circular rope although a flat belt, linked chain, or any other propulsion mechanism is equally possible. Clamp 32A uses arms 38 and hands 40 to alternate between clamping and unclamping propulsion mechanism 16, thereby attaching and detaching step 14 from propulsion mechanism 16.

As step 14 moves around the closed loop path, releasable attachment system 12A undergoes at least one change in state. Activation of actuator 28A (roller 27-track 29 combination) causes a change in the state of lock 30A (levers 34 and first spring 36), which causes a change in the state of clamp 32A (arms 38 and hands 40), ultimately either coupling or decoupling step 14 from propulsion mechanism 16. In FIG. 2A, releasable attachment system 12A is at rest or inactive and step 14 is coupled to propulsion mechanism 16. Since track 29A is absent, no pressure is being placed on roller 27, thereby allowing roller 27 to move left. Levers 34 are held in an expanded resting position by spring force of first spring 36. Arms 38 are compressed and exerting pressure on hands 40, which are securely engaging propulsion mechanism 16 to couple step 14 with propulsion mechanism 16. The coupled state depicted in FIG. 2A is advantageous when step 14 is carrying load, for example during passenger portion 24 of passenger conveyor 10.

In FIG. 2B, releasable attachment system 12A is activated to decouple step 14 from propulsion mechanism 16. First, actuator 28A is activated: track 29A exerts force on roller 27 pushing roller to the right. Second, lock 30A is unlocked: levers 34 are compressed by the movement of roller 27 and first spring 36 releases its spring force. Third, clamp 32 unclamps: movement of levers 34 causes arms 38 to move outwardly thereby releasing hands 40 from propulsion mechanism 16. This disengaged state is advantageous when step 14 is not carrying load, for example during return portion 26 of passenger conveyor 10. Within one complete loop of passenger conveyor 10, releasable attachment system 12A can alternate one or more times between the coupled position illustrated in FIG. 2A and the uncoupled position illustrated in FIG. 2B.

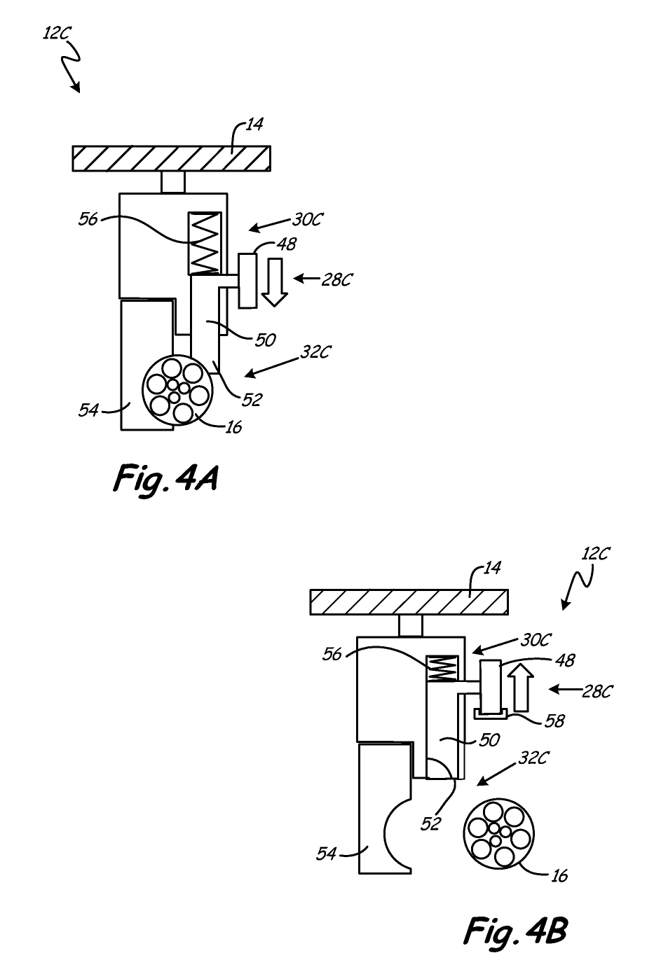

FIGS. 3A and 3B are schematic side views of a second embodiment of releasable attachment system 12B. FIG. 3A depicts releasable attachment system 12B coupling step 14 to propulsion mechanism 16, and FIG. 3B depicts releasable attachment system 12B decoupling step 14 from propulsion mechanism 16. Illustrated in FIGS. 3A and 4B are releasable attachment system 12B, propulsion mechanism 16, roller 27, actuator 28B, track 29, lock 30B, clamp 32B, arms 38, hands 40, second spring 42, levers 44, and third spring 46. In contrast to releasable attachment system 12A described above where activation triggered decoupling, activation of releasable attachment system 12B couples step 14 to propulsion mechanism 16.

Connected to an underside of step 14 is releasable attachment system 12B. Releasable attachment system 12B includes three subsystems: actuator 28B, lock 30B, and clamp 32B. Actuator 28B is the left most portion of releasable attachment system 12B and includes roller 27-track 29B combination although other means of actuation are equally possible. When activated, track 29B is in contact with roller 27. Located to the right of actuator 28B in a middle portion of releasable attachment system 12B is lock 30B. Lock 30B includes levers 44 extending outwardly from either side of roller 27 to form a box shape that surrounds second spring 42. Extending from lock 30B and forming the right most portion of releasable attachment system 12B is clamp 32B. Clamp 32B includes arms 38 extending downwardly and outwardly from second spring 42 to contact 44 before turning inwardly toward hands 40. Hands 40 extend centrally from arms 38 to engage or disengage propulsion mechanism 16. Clamp 32B further includes third spring 46 extending between a top portion of arms 38 adjacent to second spring 42. Releasable attachment system 12B is configured to provide a secure, yet releasable engagement between step and propulsion mechanism 16.

In FIG. 3A, releasable attachment system 12B is active and step 14 is coupled to propulsion mechanism 16. Track 29B pushes roller 27 to the right so that actuator 28B is active. Levers 44 transfer force to the right keeping second spring 42 compressed and lock 32B locked. The inwardly compressive force of lock 32B ensures that third spring 46 remains compressed and arms 38 and hands 40 are securely engaging propulsion mechanism 16 so that clamp 32B is clamped. The clamped or coupled state of releasable attachment system 12B depicted in FIG. 3A can be used to connect step 14 to propulsion mechanism 16 when step 14 is carrying load.

In FIG. 3B, releasable attachment system 12B is at rest and step 14 is decoupled from propulsion mechanism 16. First, actuator 28B is deactivated: track 29B ends or at least no longer contacts roller 27. Second, a lack of pressure to roller 27 causes Lock 30B to unlock. Levers 44 and second spring 42 expand outwardly and release third spring 43. Third, third spring 43 moves outwardly, pulling the arms 38 and hands 40 of clamp 32B outwardly as well. The outward movement of arms 38 and hands 40 effectively changes clamp 32B from a clamped state to an unclamped state. In this unclamped state, the engagement of propulsion mechanism 16 is terminated and releasable attachment system 12B is at rest. The decoupled state of releasable attachment system 12B depicted in FIG. 3B can be used to disengage step 14 from propulsion mechanism 16 when step 14 is not carrying load. For example, steps 14 can be decoupled from propulsion mechanism 16 on return portion 26 of passenger conveyor 10 thereby allowing steps 14 to proceed through return portion 26 with a different curvature or velocity than is necessary for carrying load.

FIGS. 4A and 4B are schematic side views of a third embodiment of releasable attachment system 12C. FIG. 4A depicts releasable attachment system 12C coupling step 14 to propulsion mechanism 16, and FIG. 4B depicts releasable attachment system 12C decoupling step 14 from propulsion mechanism 16. Illustrated in FIGS. 4A and 4B are releasable attachment system 12C, step 14, propulsion mechanism 16, actuator 28C, lock 30C, clamp 32C, roller 48, piston 50, first clamp 52, second clamp 54, spring 56, and track 58. Similar to releasable attachment system 12A described above with reference to FIGS. 2A and 2B, activation of releasable attachment system 12C decouples step 14 from propulsion mechanism 16.

Located beneath and connected to step 14, is combination actuator 28C and lock 30C. The combination actuator 28C and lock 30C includes roller 48 extending at an approximately right angle from piston 50. Located beneath and attached to combination actuator 28C and lock 30C, is two-part clamp 32C. Two part clamp 32C includes first clamp 52 attached to a lower end of piston 50, and second clamp 54 located adjacent and off to a side of piston 50. Spring 56 is attached to an upper end of piston 50 near roller 48 and is considered a component of the combination actuator 28C and lock 30C. By combining actuator 28C and lock 30C, the overall size of releasable locking system 12C is reduced providing for more compact releasable engagement system 12C between step 14 and propulsion mechanism 16.

In FIG. 4A, releasable attachment system 12C is at rest and step 14 is coupled to propulsion mechanism 16. The absence of track 58 allows roller 48, piston, and spring 56 to remain in an expanded resting position. Since combination actuator 28C and lock 30C is maintained in a steady resting state, no trigger is sent to two-part clamp 32C and thus, first clamp 52 and second clamp 54 remain in a clamped state where they both engage propulsion mechanism 16. The coupled state depicted in FIG. 4A is advantageous when step 14 is carrying load, for example during passenger portion 24 of passenger conveyor 10.

In FIG. 4B, releasable attachment system 12C is active and step 14 is decoupled from propulsion mechanism 16. Roller 48 encounters track 58 (or, alternatively, a mere change in track 58), which pushes roller 48, as well as attached piston 50 upwardly. The upward force of piston 50 compresses spring 56 by reducing its length thereby completing the change of state for combination actuator 28C and lock 30C. Since first clamp 52 is attached to piston 50, first clamp 52 is drawn upwardly by piston 50 causing clamp 32C to release its grip on propulsion mechanism 16. Propulsion mechanism 16 is then removed from second clamp 54, so that step 14 and propulsion mechanism 16 are completely separate from one another. Once releasable attachment system 12C has disengaged propulsion mechanism 16 from step 14, both propulsion mechanism 16 and step 14 are free to follow different paths, for example, around return portion 26 of passenger conveyor 10.

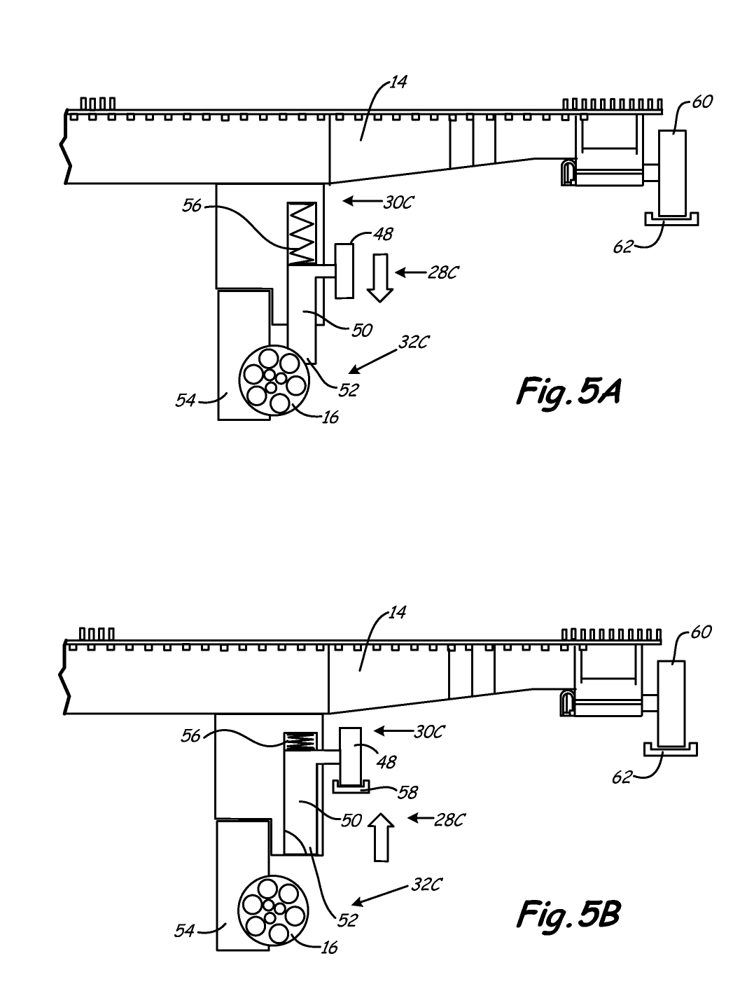

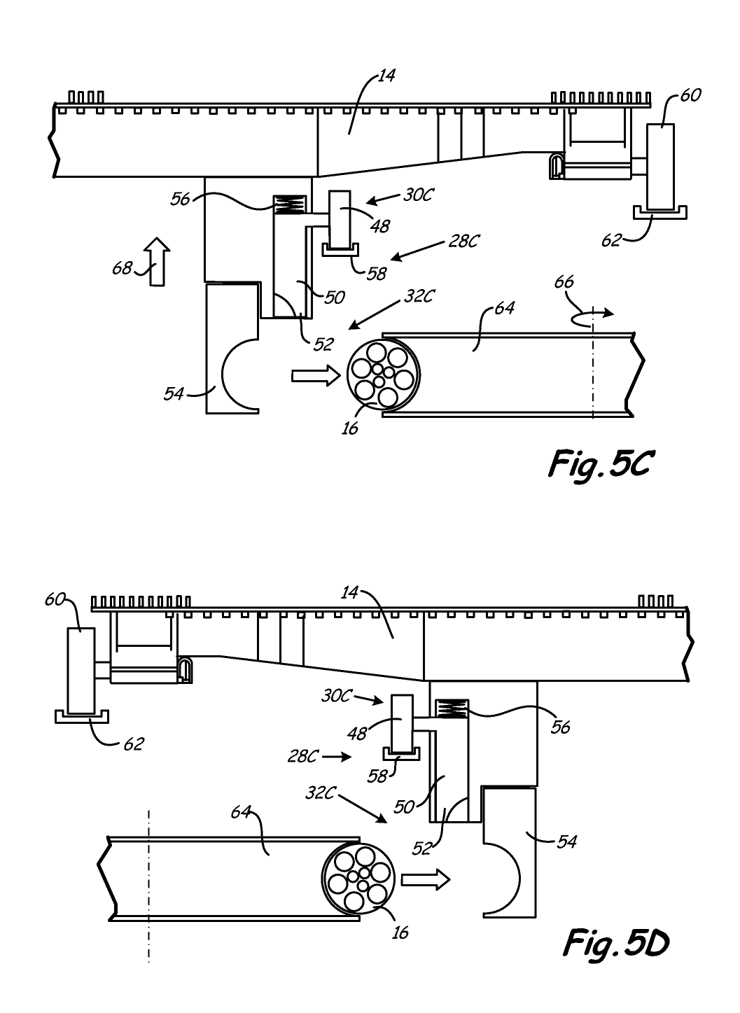

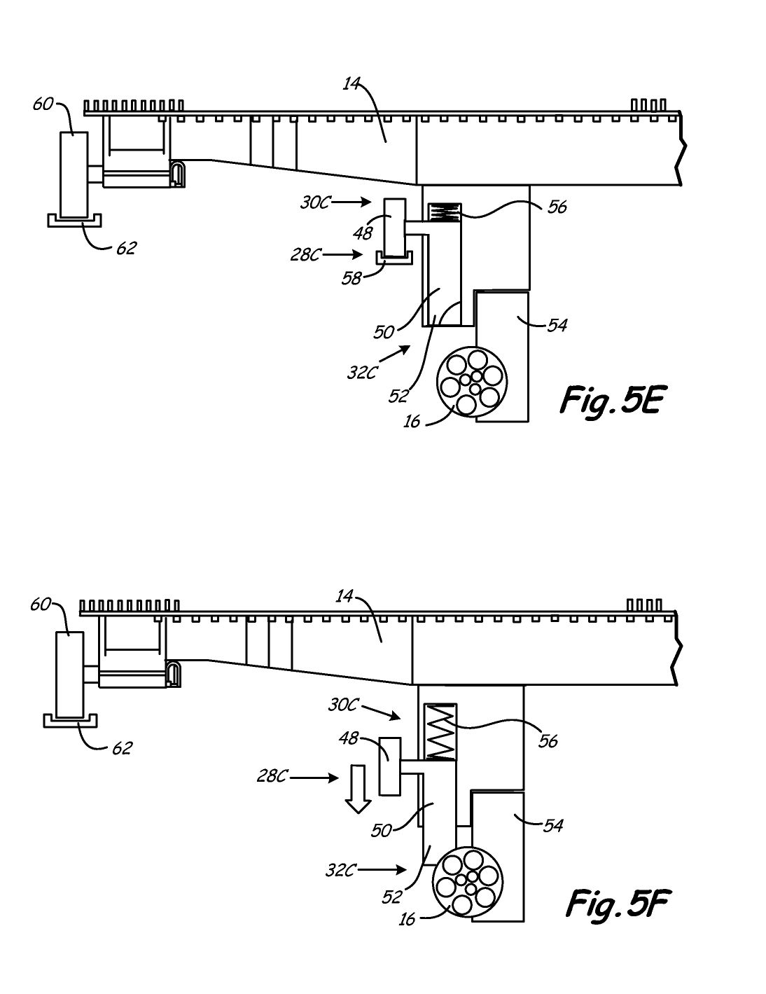

FIGS. 5A-5F are a series of schematic side views further detailing the operation of releasable attachment system 12C. Depicted in FIGS. 5A-5F are releasable attachment system 12C, step 14, propulsion mechanism 16, actuator 28C, lock 30C, clamp 32C, roller 48, piston 50, first clamp 52, second clamp 54, spring 56, and track 58, trailer wheel 60, and step track 62. The components of releasable attachment system 12C are arranged substantially as described above with reference to FIGS. 4A and 4B. In addition, trailer wheel 60 extending from a side of step 14 and step track 62 located beneath trailer wheel 60 are illustrated to give further context to releasable attachment system 12C. As known in the art, trailer wheel 60 and step track 62 guide each step 14 continuously around a closed-loop path of passenger conveyor 10. While traveling around the closed-loop passenger conveyor 10, releasable attachment system 12C engages propulsion mechanism 16 on passenger side 24 and disengages propulsion mechanism 16 on return side 26 as detailed below.

FIG. 5A depicts loaded step 14 securely engaged with propulsion mechanism 16 by releasable attachment system 12C as step 14 travels through a passenger side 24 of passenger conveyor 10. Piston 50 is biased downwardly by spring 56 so that first clamp 52 is in contact with propulsion mechanism 16. First clamp 52 presses propulsion mechanism 16 against second clamp 54 with a predetermined amount of pressure to ensure a safe connection between loaded step 14 and propulsion mechanism 16. The amount of pressure used by first clamp 52 is chosen in light of the allowable passenger load for passenger conveyor 10 and is actualized by the spring rate of spring 56.

FIG. 5B depicts step 14 immediately after unloading, such as when the step 14 enters return side 26 of passenger conveyor 10. Combination actuator 28C and lock 30C is activated to change its state as step 14 enters return side 26. More specifically, track 58 pushes upwardly on roller 48, which pulls attached piston 50 upwardly toward spring 56 and away from propulsion mechanism 16. Activation of combination actuator 28C and lock 30C triggers a change in state for clamp 32C. First clamp 52 is lifted upwardly along with piston 50 thereby releasing propulsion mechanism 16 from being pressed against second clamp 54. After completion of the change in clamp 32C state, propulsion mechanism 16 is decoupled from step 14.

FIG. 5C depicts step 14 immediately after decoupling of propulsion mechanism 16 from step 14. Step 14 continues to travel through the turn-around of return side 26. More specifically, step 14 moves in direction 68 to follow trailer wheel 58 and step track 62 around the closed-loop of passenger conveyor 10. Propulsion mechanism 16, however, is decoupled and can be pulled laterally away from releasable attachment system 12C. In the depicted embodiment, propulsion mechanism 16 is driven by traction wheel 64 in direction 66. Thus, decoupling during return side 26 allows step 14 and propulsion mechanism 16 to run with different speeds and/or in different directions.

FIGS. 5D-5F depict step 14 as it nears an end of return side 26 and prepares to enter passenger side 24. In anticipation of receiving a load, at least three things occur to couple and secure step 14 to propulsion mechanism 16. First, traction wheel 64 guides propulsion mechanism 16 back toward second clamp 54 as illustrated by FIG. 5D. Second, propulsion mechanism 16 is received back into second clamp 54 as illustrated by FIG. 5E. And third, track 58 ends thereby removing pressure exerted on wheel 48 and allowing piston 50 to drop and spring 56 to expand. Also, when piston 50 drops, first clamp 52 moves downwardly to secure propulsion mechanism 16 against second clamp 54. Thus, releasable attachment system 12C couples step 14 to propulsion mechanism 16 so that step 14 can safely enter passenger side 24 and carry load.

FIGS. 6-9 depict alternative clamps 32D-32G and propulsion mechanisms 16D-16G, respectively. Depicted in each of FIGS. 6-9, are propulsion mechanism 16, clamp 32, arms 38 and hands 40. Hands 40 of clamp 32 can assume any configuration capable of securely yet detachably engaging propulsion mechanism 16.

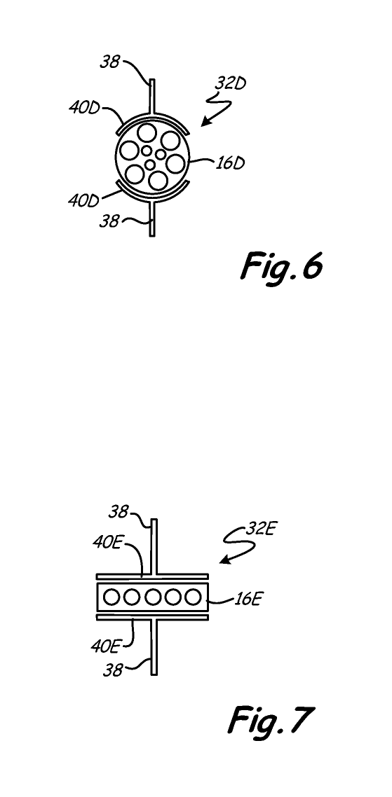

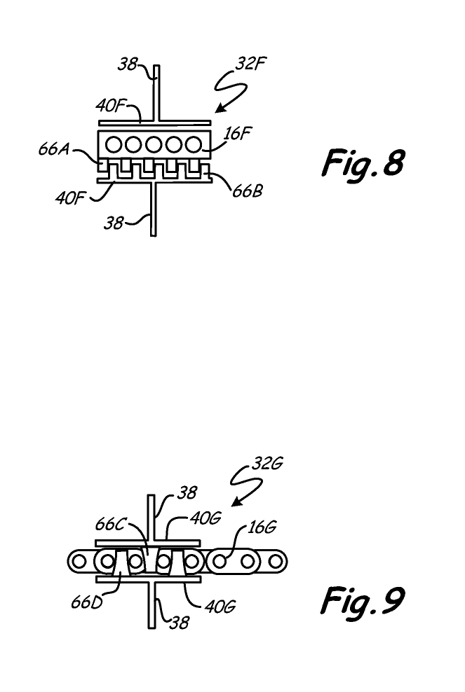

FIGS. 6-9 all show various embodiments of clamp 32 having arms 38 and hands 40 extending from arms 38. Hands 40 are of varying shapes to grasp differently shaped propulsion mechanisms 16. FIG. 6 shows hands 40D having a half moon or shell shape so that hands 40D form a friction fit with cylindrical shape or rope-shaped propulsion mechanism 16D. FIG. 7 shows flat hands 40E extending substantially perpendicular from arms 38E to form a friction fit with a flat or belt-shaped propulsion mechanism 16E. FIG. 8 shows flat, teethed hands 40F extending substantially perpendicular from arms 38F to form a positive fit with a toothed belt-shaped propulsion mechanism 16F. Teeth 66A extending downwardly from propulsion mechanism 16F mate with spaces located between teeth 66B extending upwardly from hand 40F, although other configurations are equally possible. FIG. 9 shows hands 40G extending substantially perpendicular from arms 38G to form a positive fit with chained propulsion mechanism 16G. Teeth 66C extend from both hands 40G to mate with spaces located between chain links of propulsion mechanism 16G.

The shape and material used to construct hands 40 depends largely on the dimensions of propulsion mechanism 16 and somewhat on the type of passenger conveyor 10. The clamps 32D-G illustrated in FIGS. 6A-6D are all similar in that hands 40 are pressed into contact with propulsion mechanism 16 with sufficient pressure to ensure a safe connection between pallet 14 and propulsion mechanism 16. Passenger load is a factor to consider when determining the type of clamp 30 to be used in any given passenger conveyor 10.

Vertical, horizontal, above, beneath, top, bottom, left, and right have been used throughout the specification to help define relative directions. Although the present invention has been described with reference to preferred embodiments, workers skilled in the art will recognize that changes may be made in form and detail without departing from the spirit and scope of the invention.

1. A conveyor having a releasable step locking system, the conveyor comprising:
a step for supporting load;
a propulsion mechanism connected to the step for moving the step;
a locking system removably attaching the step to the propulsion mechanism, the locking system comprising:
a clamp having an clamped state for coupling the step to the propulsion mechanism and a unclamped state for decoupling the step from the propulsion mechanism;
a lock attached to the clamp, the lock having an locked state for securing the coupling between the step and the propulsion mechanism and an unlocked state for decoupling the propulsion mechanism from the step; and
an actuator attached to both the lock and the step, the actuator capable of changing the state of the lock.

2. The conveyor of claim 1, wherein the propulsion mechanism is selected from the group consisting of: a rope, a belt and a chain.

3. The conveyor of claim 1, wherein the conveyor is selected from the group consisting of: escalator and moving walkway.

4. The conveyor of claim 1, wherein the lock includes at least one spring.

5. The conveyor of claim 4, wherein the lock is biased toward the locked state and the clamp is biased toward the clamped state such that activation of the actuator decouples the step from the propulsion mechanism.

6. The conveyor of claim 4, wherein the clamp includes at least one spring.

7. The conveyor of claim 6, wherein the lock is biased toward the unlocked state and the clamp is biased toward the unclamped state such that activation of the actuator decouples the step from the propulsion mechanism.

8. The conveyor of claim 1, wherein the clamp has a friction fit with the propulsion mechanism.

9. The conveyor of claim 1, wherein the clamp has a positive fit with the propulsion mechanism.

10. The conveyor of claim 1, wherein the actuator is selected from the group consisting of: a track and roller combination, a lever, a spring and a solenoid.

11. The conveyor of claim 1, wherein the step has a top side and a bottom side, the top side configured to support the load and the bottom side being attached to the actuator.

12. A method of moving steps in a conveyor system, the method comprising:
moving the steps around a closed loop path of the conveyor system;
engaging the steps to a propulsion mechanism for a first portion of the closed loop path where the steps carry load; and
disengaging the steps from the propulsion mechanism for a second portion of the closed loop path where the steps are load free.

13. The method of claim 12, wherein the first portion and the second portion form a complete loop of the closed loop path.

14. The method of claim 13, wherein the first portion comprises a passenger portion for transporting passengers and the second portion comprises a return portion for returning the steps to a beginning of the passenger portion.

15. The method of claim 14, wherein the second portion further comprises a turnaround located between the passenger portion and the return portion.

16. A method of attaching and detaching a step to a propulsion mechanism for a conveyor system, the method comprising:
activating a locking system that attaches the step to the propulsion mechanism in the conveyor system;
changing a lock from a first lock state to a second lock state in response to the activation of the locking system; and
changing a clamp from a first clamp state to a second clamp state in response to the change in lock state such that the attachment between the step and the propulsion mechanism is altered.

17. The method of claim 16, further comprising:
deactivating the locking system that attaches the step to the propulsion mechanism in the passenger conveyor system;
changing the lock from the second lock state to the first lock state in response to the activation of the locking system; and
changing the clamp from the second clamp state to the first clamp state in response to the change in lock state such that the attachment between the step and the propulsion mechanism is altered.

18. The method of claim 16, wherein changing the clamp from the first clamp state to the second clamp state attaches the step to the propulsion mechanism.

19. The method of claim 16, wherein changing a clamp from a first clamp state to a second clamp state detaches the step from the propulsion mechanism.

20. The method of claim 16, wherein the conveyor system is a moving walkway.
